(19) United States
(12) Patent Application Publication
(10) Pub. No.: US 2026/0045069 A1
(43) Pub. Date: Feb. 12, 2026

(54) SYSTEMS AND METHODS FOR MULTIMODAL GROUND TRUTH SAMPLING

(71) Applicant: NOBLIS, INC., Reston, VA (US)

(72) Inventors: Ryan RUBEL, Reston, VA (US); Andrew DUDASH, Reston, VA (US)

(73) Assignee: NOBLIS, INC., Reston, VA (US)

(21) Appl. No.: 18/800,325

(22) Filed: Aug. 12, 2024

(51) Int. Cl. G06V 10/774; G06T 3/02; G06T 11/00; G06T 15/40; G06T 17/20

(52) U.S. Cl. CPC G06V 10/774; G06T 3/02; G06T 11/00; G06T 15/40; G06T 17/20; G06T 2210/12; G06T 2210/21; G06T 2210/56

(57) ABSTRACT

In some embodiments, a method of multimodal ground truth sampling for creating synthetic multimodal training data is provided, the method performed by one or more processors, the method comprising: selecting a source object from a dataset; determining a valid pose transformation from a set of proposed pose transformations; applying the valid pose transformation to the source object to create a transformed object; generating synthetic image data based on the transformed object and a destination image; generating synthetic point cloud data based on the transformed object and a destination point cloud; and training a computer vision machine learning model from synthetic multimodal training data comprising the synthetic image data and the synthetic point cloud data.

### FIELD

This disclosure relates generally to the field of learned object detection, and more specifically, to systems and methods for ground truth sampling and augmentation of multimodal datasets.

### BACKGROUND

Learned object detection models, such as computer vision models used in autonomous vehicles, are often trained using multimodal data. Multimodal data includes combined LiDAR and image sensor data. Multimodal data is beneficial for learned object detection. Sparse, 3D LiDAR point clouds are useful for object localization, while dense, 2D images are useful for object recognition. Despite having both of these benefits, multimodal object detection algorithms only narrowly outperform their LiDAR-only counterparts. This can be largely attributed to the difficulties in preserving correspondences between 3D and 2D data through geometric transforms, which present challenges for augmenting multimodal datasets.

Since learned object detection models are more accurate when trained from robust datasets of different classes of objects in a diverse array of poses, improving the methods of augmenting these multimodal datasets will result in more accurate learned object detection models. Ground truth sampling is one method of augmenting detection datasets that synthetically adds objects of interest and their detection labels to existing data. For example, a ground truth sampling method may take, as an input, an image and its associated detection label, and then paste objects of interest into the image and add their associated detection labels to the label vector.

### SUMMARY

Current multimodal ground truth sampling methods neglect object-level transformations such as uniform scaling, translation, and rotation that allow for out-of-plane object transformations, which would greatly improve the diversity of data in object detection datasets. Described herein are methods for multimodal ground truth sampling that can incorporate these object-level transformations and thus greatly improve the diversity and robustness of object detection datasets without the need for manually collecting additional data, along with systems for performing the same. The methods can involve utilizing a dataset that includes both source images and source LiDAR point clouds for training a computer vision model. The source images and source LiDAR point clouds include image and LiDAR data associated with a source object, such as a car, a bicycle, a road obstacle, and so on.

In some embodiments, a dataset of “cut” source objects can be created based on the source images and source point clouds. Then, a method may include selecting a source object from the dataset and applying a pose transformation to the source object to create a transformed object. This transformed object can be “pasted” into a destination image and a destination point cloud which may be different from the source image and source point cloud that the source object came from. Various sampling techniques can be performed on the source image and source point cloud and/or a source object LiDAR mesh to obtain information on realistic pixel values and LiDAR intensities. These pixel values and LiDAR intensities can then be applied to the transformed object in the destination image and point cloud to create synthetic image data and LiDAR data.

A computer vision machine learning model can be trained from this synthetic image data and LiDAR data, improving the diversity of the training data and thereby improving the accuracy of the model. Further, a method may involve rejection sampling, in which proposed pose transformations that would cause the transformed object to appear distorted, unrealistic, or occluded by other objects in the destination image/point cloud may be rejected. This can help to ensure that only realistic pose transformations are applied to create the transformed object. This results in more realistic synthetic image data and LiDAR data used to train the computer vision model, which can help reduce errors in object detection that are a result of learned biases.

In some embodiments, a method of multimodal ground truth sampling for creating synthetic multimodal training data is provided. The method may be performed by one or more processors. In some embodiments, the method comprises: selecting a source object from a dataset; determining a valid pose transformation from a set of proposed pose transformations; applying the valid pose transformation to the source object to create a transformed object; generating synthetic image data based on the transformed object and a destination image; generating synthetic point cloud data based on the transformed object and a destination point cloud; and training a computer vision machine learning model from synthetic multimodal training data comprising the synthetic image data and the synthetic point cloud data.

In some embodiments, generating synthetic image data based on the transformed object and the destination image comprises: intersecting simulated camera rays with locations on a transformed object mesh, wherein the transformed object mesh corresponds to the transformed object; sampling pixel values in a source image based on the intersected locations, wherein the source image corresponds to the source object; and replacing pixel values of the destination image with the sampled pixel values in the source image.

In some embodiments, generating synthetic point cloud data based on the transformed object and the destination point cloud comprises: removing points from the destination point cloud that are occluded by the transformed object; intersecting simulated LiDAR rays with locations on a transformed object mesh, wherein the transformed object mesh corresponds to the transformed object; sampling intensity values in a source object mesh based on the intersected locations, wherein the source object mesh corresponds to the source object; adding points to the destination point cloud at locations on the transformed object corresponding to the intersected locations; and assigning intensity values for the added points based on the sampled intensity values.

In some embodiments, the method comprises labeling the synthetic multimodal training data with one or more of an object class, a yaw, a length, a width, a height, an x-coordinate, a y-coordinate, or a z-coordinate.

In some embodiments, prior to selecting a source object from a dataset, the method comprises: combining LiDAR points from one or more source point clouds into a combined point cloud; constructing a source object mesh from the combined point cloud; constructing a source object from the source object mesh and one or more source images; and saving the source object to the dataset.

In some embodiments, constructing the source object mesh from the combined point cloud comprises removing outlier points.

In some embodiments, constructing the source object mesh from the combined point cloud comprises removing points corresponding to a ground plane.

In some embodiments, determining a valid pose transformation from a set of proposed pose transformations comprises determining that applying the proposed pose transformation to the source object to create a transformed object would not cause the transformed object to violate one or more occlusion criteria.

In some embodiments, determining a valid pose transformation from a set of proposed pose transformations comprises: measuring a first pixel length of a bounding box around the source object; measuring a second pixel length of a bounding box around the source object transformed using a proposed pose transformation; computing a ratio of the second pixel length to the first pixel length; and determining that the ratio does not exceed a distortion threshold.

In some embodiments, determining a valid pose transformation from a set of proposed pose transformations comprises determining that applying the proposed pose transformation to the source object to create a transformed object would not cause the transformed object to overlap with one or more objects in the destination image.

In some embodiments, the source object is one of a vehicle, a pedestrian, or a bicyclist.

In some embodiments, a system for multimodal ground truth sampling for creating synthetic multimodal training data is provided, the system comprising: one or more processors; and memory storing computer program code executable by the one or more processors to cause the system to: select a source object from a dataset; determine a valid pose transformation from a set of proposed pose transformations; apply the valid pose transformation to the source object to create a transformed object; generate synthetic image data based on the transformed object and a destination image; generate synthetic point cloud data based on the transformed object and a destination point cloud; and train a computer vision machine learning model from synthetic multimodal training data comprising the synthetic image data and the synthetic point cloud data.

In some embodiments, generating synthetic image data based on the transformed object and the destination image comprises: intersecting simulated camera rays with locations on a transformed object mesh, wherein the transformed object mesh corresponds to the transformed object; sampling pixel values in a source image based on the intersected locations, wherein the source image corresponds to the source object; and replacing pixel values of the destination image with the sampled pixel values in the source image.

In some embodiments, generating synthetic point cloud data based on the transformed object and the destination point cloud comprises: removing points from the destination point cloud that are occluded by the transformed object; intersecting simulated LiDAR rays with locations on a transformed object mesh, wherein the transformed object mesh corresponds to the transformed object; sampling intensity values in a source object mesh based on the intersected locations, wherein the source object mesh corresponds to the source object; adding points to the destination point cloud at locations on the transformed object corresponding to the intersected locations; and assigning intensity values for the added points based on the sampled intensity values.

In some embodiments, the system is further caused to label the synthetic multimodal training data with one or more of an object class, a yaw, a length, a width, a height, an x-coordinate, a y-coordinate, or a z-coordinate.

In some embodiments, prior to selecting a source object from a dataset, the system is caused to: combine LiDAR points from one or more source point clouds into a combined point cloud; construct a source object mesh from the combined point cloud; construct a source object from the source object mesh and one or more source images; and save the source object to the dataset.

In some embodiments, constructing the source object mesh from the combined point cloud comprises removing outlier points.

In some embodiments, constructing the source object mesh from the combined point cloud comprises removing points corresponding to a ground plane.

In some embodiments, determining a valid pose transformation from a set of proposed pose transformations comprises determining that applying the proposed pose transformation to the source object to create a transformed object would not cause the transformed object to violate one or more occlusion criteria.

In some embodiments, determining a valid pose transformation from a set of proposed pose transformations comprises: measuring a first pixel length of a bounding box around the source object; measuring a second pixel length of a bounding box around the source object transformed using a proposed pose transformation; computing a ratio of the second pixel length to the first pixel length; and determining that the ratio does not exceed a distortion threshold.

In some embodiments, determining a valid pose transformation from a set of proposed pose transformations comprises determining that applying the proposed pose transformation to the source object to create a transformed object would not cause the transformed object to overlap with one or more objects in the destination image.

In some embodiments, the source object is one of a vehicle, a pedestrian, or a bicyclist.

In some embodiments, a non-transitory computer readable storage medium storing one or more programs is provided, the one or more programs comprising instructions, which, when executed by a system, cause the system to: select a source object from a dataset; determine a valid pose transformation from a set of proposed pose transformations; apply the valid pose transformation to the source object to create a transformed object; generate synthetic image data based on the transformed object and a destination image; generate synthetic point cloud data based on the transformed object and a destination point cloud; and train a computer vision machine learning model from synthetic multimodal training data comprising the synthetic image data and the synthetic point cloud data.

### BRIEF DESCRIPTION OF THE FIGURES

The patent or application file contains at least one drawing executed in color. Copies of this patent or patent application publication with color drawing(s) will be provided by the Office upon request and payment of the necessary fee.

A better understanding of the features and advantages of the present disclosure will be obtained by reference to the following detailed description that sets forth illustrative embodiments, in which the principles of the disclosure are utilized, and the accompanying drawings of which:

FIG. 1 illustrates a method of multimodal ground truth sampling, according to some embodiments.

FIG. 2 illustrates the construction of a database of source objects, according to some embodiments.

FIG. 3 illustrates the construction of an object mesh from a source point cloud, according to some embodiments.

FIG. 4 illustrates ground truth sampling of image data, according to some embodiments.

FIG. 5 illustrates ground truth sampling of LiDAR data, according to some embodiments.

FIG. 6 illustrates a computer, according to some embodiments.

FIG. 7 illustrates synthetic multimodal training data, according to some embodiments.

### DETAILED DESCRIPTION

Described herein are methods and systems for ground truth sampling that can be used to train a computer vision machine learning model without the need for collecting additional training data manually. The methods and systems described herein are multimodal, meaning that meaning that they can be performed in both the image and LiDAR modalities.

In some embodiments, a method of multimodal ground truth sampling for creating synthetic multimodal training data is provided. The method may be implemented by a computer comprising one or more processors. The method may include selecting a source object from a dataset. The dataset may include source objects representing objects (e.g. pedestrians, cyclists, and cars) that were “cut” from an existing dataset of source images and source point clouds for training computer vision models (e.g. KITTI, Waymo, nuScenes, etc.). The method may also include determining a valid pose transformation from a set of proposed pose transformations by sampling proposed pose transformations on a mesh of the source object. For example, a proposed pose transformation may be determined to be “valid” so long as it would not distort the object to an unrealistic degree or cause the object to overlap with other objects in a destination image or point cloud.

Valid pose transformations may then be applied to the source object to create a transformed object. This transformed object may be “pasted” into a destination image or destination point cloud. “Pasting” the transformed object may involve replacing pixel values in the destination image and assigning intensity values to points in the destination point cloud by applying various sampling techniques to the source image and/or a source object mesh, creating synthetic, augmented image data and point cloud data. A computer vision machine learning model may then be trained from the synthetic image data and LiDAR data, after which the method can be repeated for as long as training is to continue.

In the following description of the various embodiments, it is to be understood that the singular forms “a,” “an,” and “the” used in the following description are intended to include the plural forms as well, unless the context clearly indicates otherwise. It is also to be understood that the term “and/or” as used herein refers to and encompasses any and all possible combinations of one or more of the associated listed items. It is further to be understood that the terms “includes, “including,” “comprises,” and/or “comprising,” when used herein, specify the presence of stated features, integers, steps, operations, elements, components, and/or units but do not preclude the presence or addition of one or more other features, integers, steps, operations, elements, components, units, and/or groups thereof.

Certain aspects of the present disclosure include process steps and instructions described herein in the form of an algorithm. It should be noted that the process steps and instructions of the present disclosure could be embodied in software, firmware, or hardware and, when embodied in software, could be downloaded to reside on and be operated from different platforms used by a variety of operating systems. Unless specifically stated otherwise as apparent from the following discussion, it is appreciated that, throughout the description, discussions utilizing terms such as “processing,” “computing,” “calculating,” “determining,” “displaying,” “generating” or the like, refer to the action and processes of a computer system, or similar electronic computing device, that manipulates and transforms data represented as physical (electronic) quantities within the computer system memories or registers or other such information storage, transmission, or display devices.

The present disclosure in some embodiments also relates to a device for performing the operations herein. This device may be specially constructed for the required purposes, or it may comprise a general-purpose computer selectively activated or reconfigured by a computer program stored in the computer. Such a computer program may be stored in a non-transitory, computer readable storage medium, such as, but not limited to, any type of disk, including floppy disks, USB flash drives, external hard drives, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each connected to a computer system bus. Furthermore, the computing systems referred to in the specification may include a single processor or may be architectures employing multiple processor designs, such as for performing different functions or for increased computing capability. Suitable processors include central processing units (CPUs), graphical processing units (GPUs), field programmable gate arrays (FPGAs), and ASICs.

The methods, devices, and systems described herein are not inherently related to any particular computer or other apparatus. Various general-purpose systems may also be used with programs in accordance with the teachings herein, or it may prove convenient to construct a more specialized apparatus to perform the required method steps. The structure for a variety of these systems will appear from the description below. In addition, the present invention is not described with reference to any particular programming language. It will be appreciated that a variety of programming languages may be used to implement the teachings of the present disclosure as described herein.

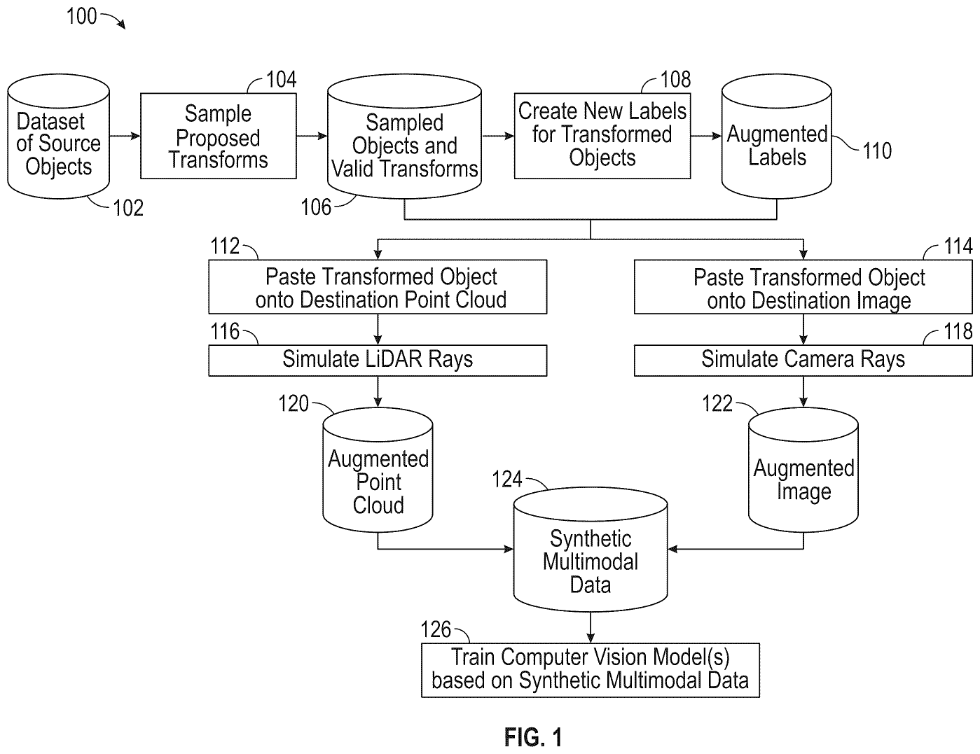

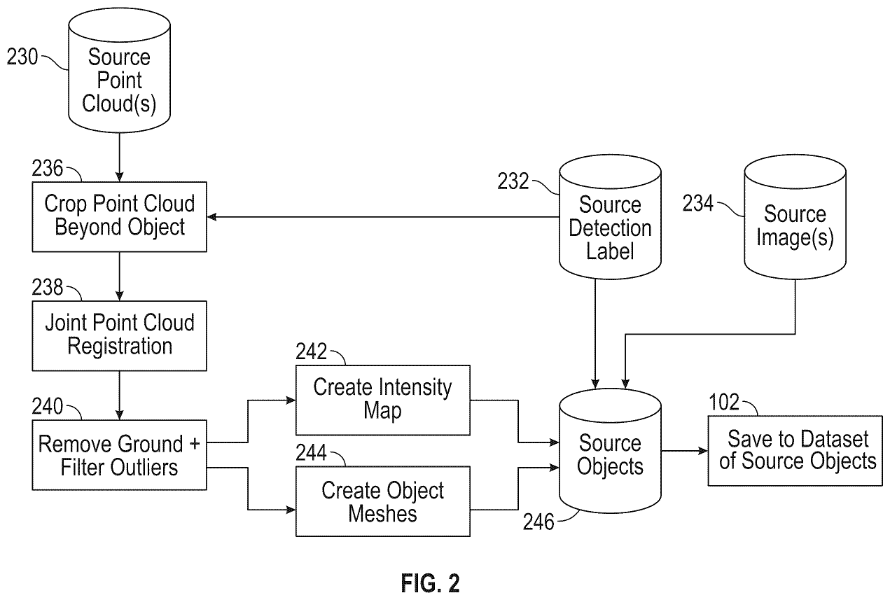

FIG. 1 shows an exemplary multimodal ground truth sampling method 100, according to some embodiments. One or more steps of method 100 may be performed “on the fly,” e.g. in quick succession during a training session for a computer vision machine learning model. At step 102, the method may include selecting a source object from a dataset of source objects. The source objects may have been “cut” from source images and/or source point clouds from an existing computer vision dataset, such as KITTI, Waymo, nuScenes, etc. Some embodiments of the method may involve assembling a dataset of “cut” source objects that may be stored (e.g. in system memory, denoted herein as a “disk”) prior to training the computer vision model, which will be described with respect to FIG. 2. At step 104, the method may involve determining a valid pose transformation from a set of proposed pose transformations by sampling proposed pose transformations on the selected source object's mesh. In some embodiments, to sample proposed pose transformations on the source object's mesh, a temporary copy of the source object mesh may be made for each proposed pose transformation, and the proposed pose transformations can be applied to the temporary copy such that sampling may take place rapidly. Applying a proposed pose transformation may change the source object mesh from a first pose, e.g. a ground truth or other pre-existing pose of the object, to a second pose.

When the source object is transformed and sent (e.g. “pasted”) into a new scene, the resulting scene (whether it is an image or point cloud) as well as the object labels of the pasted object should all be computed in terms of the same frame. Starting with the object label, a bounding box label can be defined as:

$$L := ( \vec{𝓍𝓎𝓏} , \vec{ℓ𝒽ω} , θ ) \qquad 1 )$$

where [symbol] , [symbol] , and θ are the position, dimensions, and yaw of the object's bounding box label, respectively. In many computer vision datasets, such as KITTI, ground truth labels are recorded in the camera frame. Accordingly, a function H(·) mapping a label L to a source object's pose with respect to the camera,

$${T}_{label ← disk} ,$$

can be defined as:

$$H ( L ) := [ \begin{matrix}{R}_{y} ( θ ) & \vec{𝓍𝓎𝓏} \\ {\vec{0}}^{⊤} & 1\end{matrix} ] \qquad ( 2 )$$

A proposed pose transformation that may send (e.g. “paste”) a transformed object mesh into a new scene can be modeled by:

$${T}_{camAUG ← disk} = H ( {L}_{AUG} ) {S}_{rand} {T}_{Δ} {T}_{label ← disk} \qquad 3 )$$

where L_{AUG} is the constructed ground truth label describing the pasted object, S_{rand} is a random uniform scaling, T is a correction term that forces the object mesh to face the sensor, and
T is the transform that maps from the coordinate frame in which object meshes are label←disk
   stored on the disk to a frame that is acted upon by H(·). The synthetic image, point cloud, and label of each transformed object can all be computed in terms of

$${T}_{camAUG ← disk} .$$

In some embodiments, a proposed pose transformation may include a randomly generated scale (e.g. S_{rand}), as well as x- and z-dimensions. A y-dimension (height) can be proposed such that the object is placed on the ground plane. The proposed pose transformation can include a combination of scaling, rotation, and translation of the source object mesh into a new pose. In some embodiments, various proposed transformations associated with the source object may be sampled randomly or semi-randomly. For example, let 4-7 below be randomly sampled components of a proposed transformation.

$${x}_{rand} ∼ U ( {x}_{min} , {x}_{max} ) \qquad 4 )$$

$${s}_{rand} ∼ U ( {s}_{min} , {s}_{max} ) \qquad 5 )$$

$${z}_{rand} ∼ U ( {z}_{min} , {z}_{max} ) \qquad 6 )$$

$${θ}_{rand} ∼ U ( - π , π ) \qquad 7 )$$

### Then:

$${L}_{r a n d} := ( 〈 {x}_{rand} , 0 , {𝓏}_{rand} 〉 , {𝓈}_{rand} {SOURCE}_{} , {θ}_{rand} ) \qquad 8 )$$

$${𝒮}_{rand} := [ \begin{matrix}{𝒮}_{rand} {I}_{3} & 0 \\ {\vec{0}}^{⊤} & 1\end{matrix} ] \qquad 9 )$$

Accordingly, the set of proposed transformations associated with a source object may be based on various properties of the source object.

The proposed pose transformation may include a randomly generated reflection or rotation parity (e.g. TA), which may be used to avoid revealing a face of the source object that was unobserved in the source dataset if the transformation is applied. Since this face of the object was not actually observed in the real world, it would be more prone to distortions and inaccuracies. For each source object, the sides of the object (e.g. front, back, left, or right) that were actually observed can be computed from detection labels from the source image or source point cloud. If a proposed transformation would cause an unobserved face to be revealed in the transformed object mesh, a 180-degree rotation about the source object's y-axis can be added to the proposed pose transformation a to prevent an unobserved front or back side from being revealed. Similarly, the proposed pose transformation may include a reflection so as to prevent an unobserved left or right side of the source object from being revealed.

More specifically, the determination of whether the object's exposed faces in the augmented scene differ from its exposed faces in the source scene can be made by the following comparison:

$$T ( \vec{t} , θ ) := [ \begin{matrix}{R}_{y} ( θ ) & t \\ {\vec{0}}^{⊤} & 1\end{matrix} ] \qquad 10 )$$

$$\begin{matrix}{ℓ}_{s i g n} ( x , 𝓏 , θ ) := - sign ( T ( 〈 x , 0 , 𝓏 〉 , θ ) \vec{{e}_{1}} \cdot 〈 x , 0 , 𝓏 , 0 〉 ) \\ = - sign ( 〈 x , 0 , 𝓏 , 0 〉 \cdot 〈 cos θ , 0 , - sin θ , 0 〉 ) \\ = - sign ( x cos θ - 𝓏 sin θ )\end{matrix} \qquad 11 )$$

$$\begin{matrix}{W}_{s i g n} ( x , 𝓏 , θ ) := - sign ( T ( 〈 x , 0 , 𝓏 〉 , θ ) {\vec{e}}_{3} \cdot 〈 x , 0 , 𝓏 , 0 〉 ) \\ = - sign ( 〈 x , 0 , 𝓏 , 0 〉 \cdot 〈 sin θ , 0 , cos θ , 0 〉 ) \\ = - sign ( x sin θ + 𝓏 cos θ )\end{matrix} \qquad 12 )$$

The front of the object faces the sensor if and only if [symbol] _{sign} (x, z, θ)>0. Likewise, the right side of the object faces the center if and only if W_{sign}(x, z, θ)>0.

To ensure that the randomly sampled proposed transformation

$$\begin{matrix}T \\ camAUG ← disk\end{matrix}$$

does not expose a face of the object that was not observed in the source data used to construct it, the exposed faces of the object with the randomly sampled proposed transformation applied (rand) can be compared against those in the source (SRC) data:

$${ℓ}_{Δ} := {ℓ}_{s i g n} ( {x}_{rand} , {𝓏}_{rand} , {θ}_{rand} ) \neq {ℓ}_{s i g n} ( {x}_{SRC} , {𝓏}_{SRC} , {θ}_{S R C} ) \qquad 13 )$$

$${W}_{Δ} := {W}_{s i g n} ( {x}_{rand} , {𝓏}_{rand} , {θ}_{rand} ) \neq {W}_{s i g n} ( {x}_{SRC} , {𝓏}_{SRC} , {θ}_{S R C} ) \qquad 14 )$$

where the ground truth label associated with the object's source data is defined as:

$${L}_{S R C} := ( 〈 {x}_{SRC} , {y}_{SRC} , {𝓏}_{S R C} 〉 , 〈 {ℓ}_{SRC} , {h}_{SRC} , {w}_{SRC} 〉 , {θ}_{SRC} ) \qquad 15 )$$

if [symbol] _{Δ} (respectively W_{Δ}) are determined, then the orientation of the front/back (respectively left/right) of the object with respect to the sensor has changed from the source data and should be corrected.

One can correct for [symbol] _{Δ}, a change in forward/backward direction, by altering the sampled yaw, θ_{rand}, by θ_{Δ}:

$${θ}_{Δ} := \{ \begin{matrix}π & if {ℓ}_{Δ} ∧ ( {θ}_{rand} < 0 ) \\ - π & if {ℓ}_{Δ} ∧ ( {θ}_{rand} \geq 0 ) \\ 0 & otherwise\end{matrix} \qquad 16 )$$

One can correct for W_{Δ}, a change in left/right direction, by applying a reflection through the plane of symmetry. Since a yaw rotation of ±π also reflects the left/right side with respect to the camera, the condition to apply the reflection is inverted when a rotation is to be applied. This reflection is computed as:

$${T}_{Δ} = [ \begin{matrix}1 & 0 & 0 & 0 \\ 0 & 1 & 0 & 0 \\ 0 & 0 & {𝓏}_{Δ} & 0 \\ 0 & 0 & 0 & 1\end{matrix} ] \qquad 17 )$$

where

$${𝓏}_{Δ} := \{ \begin{matrix}- 1 & if {W}_{Δ} ⊕ {ℓ}_{Δ} \\ 1 & otherwise\end{matrix} \qquad 18 )$$

Still referring to step 104, sampling proposed pose transformations may involve rejecting unrealistic proposed transformations that would cause the transformed object to violate various criteria if the transformation were to be applied. The criteria may be used to quantify the amount of object distortion that would result by applying the proposed transformation. For example, some transformations would distort the object to an unrealistic degree if applied, while others could cause a part of the object to overlap with existing objects in the destination image/point cloud if applied. Accordingly, a rejection sampling process may take place at step 104 so that the resulting transformed object has a realistic pose.

In some embodiments, the rejection sampling at step 104 may involve measuring pixel lengths along a length and width of a potential bounding box around the object with the proposed transformation applied (AUG) and comparing these pixel lengths to the corresponding pixel lengths of a bounding box around the source object (SRC). If a ratio ( [symbol] ) of the pixel lengths/widths of the proposed bounding box over the pixel lengths/widths of the source object bounding box is too high, this may indicate that the object with the proposed transformation applied is distorted and that the proposed transformation would yield a transformed object that is undesirable for inclusion in the dataset.

[symbol]

can be computed as:

$$\begin{matrix}= {ℓ}_{s i g n} ( x , 𝓏 , θ ) & {ℓ}_{d i s k} = \frac{1}{2} [ \begin{matrix} & - \\ 0 & 0 \\ & \\ 2 & 2\end{matrix} ]\end{matrix} \qquad 19 )$$

$$\begin{matrix}= {w}_{s i g n} ( x , 𝓏 , θ ) & = \frac{1}{2} [ \begin{matrix}ℓ {k}_{ℓ} & ℓ {k}_{ℓ} \\ 0 & 0 \\ & - \\ 2 & 2\end{matrix} ]\end{matrix} \qquad 20 )$$

$$\begin{matrix}[ \begin{matrix} & \\ & \\ 1 & 1\end{matrix} ] = \begin{matrix}P \\ imgFRAME ← disk\end{matrix} \begin{matrix}{ℓ}_{disk} \\ \end{matrix} \\ {ℓ}_{p r o j F R A M E} = \vert - \vert\end{matrix} \qquad 21 )$$

$$\begin{matrix}[ \begin{matrix} & \\ & \\ 1 & 1\end{matrix} ] = \begin{matrix}P \\ imgFRAME ← disk\end{matrix} \begin{matrix} \\ \end{matrix} \\ = \vert - \vert\end{matrix} \qquad 22 )$$

where FRAME∈{AUG, SRC};

$$= \frac{}{} \qquad 23 )$$

$$= \frac{}{} \qquad 24 )$$

For example, if [symbol] and/or [symbol] exceed a predefined threshold, dₘₐₓ, the proposed pose transformation can be rejected. In some embodiments, the threshold ratio of dₘₐₓ may be greater than or equal 0.1, 0.25, 0.5, 0.75, 1, 1.25, or 1.5. In some embodiments, the threshold ratio of dₘₐₓ may be less than or equal to 0.25, 0.5, 0.75, 1, 1.25, 1.5, or 1.75. In some embodiments, the ratio dₘₐₓ may be 0.1-1.75, 0.1-1.5, 0.1-1.25, 0.1-1, 0.25-1.5, 0.25-1.25, or 0.25-1.

Additionally, or alternatively, step 104 may include determining whether the proposed transformation would cause the object to be occluded by other points, objects, or bounding boxes in the destination image or destination point cloud if the transformation were to be applied. This may involve projecting the object with the proposed transformation applied onto the ground based on the average height of points underneath a bounding box. Once the transformed object is translated to the ground, the occlusion criteria may include determining whether the transformed object is located behind existing LiDAR points, objects, or bounding boxes in the destination point cloud, which could suggest foreground occlusion. These proposed transformations could be rejected at step 104.

Additional occlusion criteria may include determining whether there are too few points of the transformed object on the ground plane, which would also be indicative of occlusion and would cause the proposed transformation to be rejected. In some embodiments, less than or equal to 20, 18, 16, 14, 12, or 10 points of the transformed object on the ground plane may be indicative of occlusion. The occlusion criteria may also involve estimating ground planes during preprocessing using sequential LiDAR point clouds and adjusting the average height estimate based on the estimated ground plane. These rejection sampling steps can help ensure that synthetic image and point cloud data is generated from objects that have been transformed in a realistic manner, thus improving the overall accuracy of the synthetic multimodal data. Step 104 may result in a set of sampled objects, each object having a valid pose transformation, shown at 106. Any objects from the dataset of source objects for which a valid pose transformation was not determined at step 104 may be disregarded in the remaining steps of method 100.

At step 108, augmented labels 110 for the transformed objects may be created, either by applying the valid pose transformation to the ground truth labels in the source image/source point cloud to transform the existing labels, or by computing new labels from the transformed objects. The resulting augmented labels 110 may include an object class, a bounding box including a yaw, a length, a width, and a height, and an x-coordinate, a y-coordinate, and/or a z-coordinate.

### For Example, a Synthetic (AUG) Label May be Constructed as:

$${L}_{AUG} := ( {AUG}_{} , {AUG}_{} , {θ}_{AUG} ) \qquad 25 )$$

$${A U G}_{} = 〈 {x}_{r a nd ,} ( {L}_{r a n d} ) , {𝓏}_{r a n d} 〉 \qquad 26 )$$

$${A U G}_{} = {s}_{r a n d} {S R C}_{} \qquad 27 )$$

$${θ}_{A U G} = {θ}_{rand} + {θ}_{Δ} \qquad 28 )$$

Once the valid transformations and the augmented labels are determined, the valid transformations may be applied to their corresponding source object to create a transformed object. This transformed object, along with its augmented labels, can be pasted into a destination point cloud 112 and a destination image 114 to create an augmented image and point cloud. In the destination point cloud, points occluded by the transformed object can be removed. As will be further described with respect to FIG. 2, the “destination” point cloud or image that the transformed object is pasted into is typically different from the particular source image or point cloud that the source object came from (e.g. from the KITTI dataset) so that the computer vision model is ultimately trained from diversified training data. In some embodiments, the destination image and/or destination point cloud is randomly selected from a dataset of nonaugmented images/point clouds (e.g. another image/point cloud from KITTI that is different from the image/point cloud that the source object came from). In some embodiments, multiple source objects may be transformed and pasted into the same destination image and/or point cloud, such that steps 112-122 may be performed for each transformed object that has been pasted in a particular destination image and/or point cloud.

Various techniques may be used to interpolate realistic pixel values and LiDAR intensity values for the transformed object in its new scene at steps 116-118. For example, in the image modality, a cut object is “pasted” into the destination image by transforming the saved object mesh into the camera frame of the destination image via

$$\begin{matrix}T \\ camA UG ← disk\end{matrix} ,$$

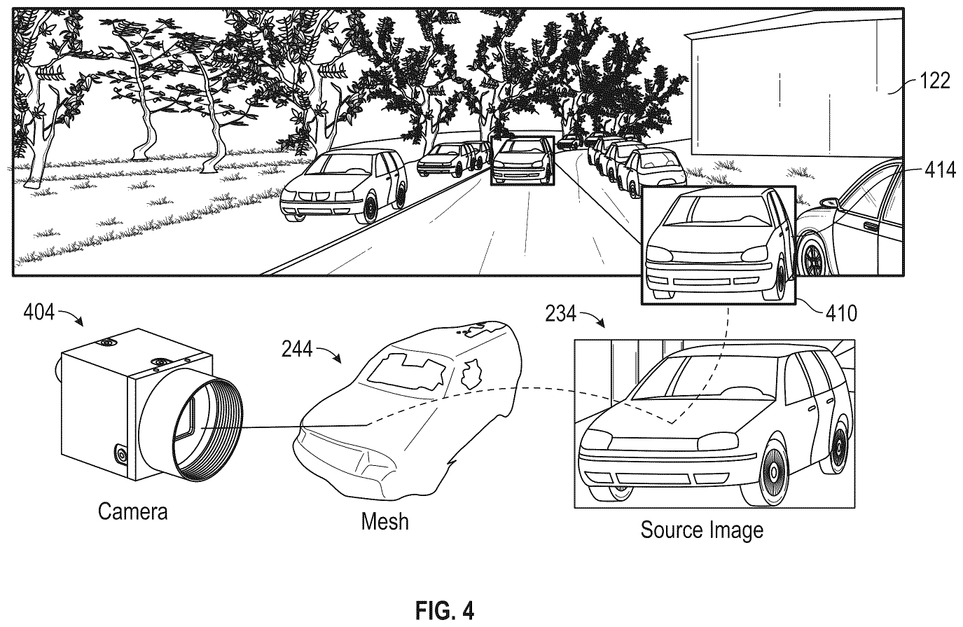

computed using Equation 3 above. At step 118, a method of interpolating pixel values is shown in FIG. 4. As shown, camera rays 404 can be simulated through pixels of the destination image and intersected with an object mesh 244 having the valid pose transformation applied. The manner in which this object mesh can be created will be described with respect to FIG. 2. The simulated camera rays 404 may be generated in accordance with the camera intrinsics associated with the destination image.

For example, the camera ray \vec{r}_{camAUG}:=(\vec{o}_{camAUG}, \vec{d}_{camAUG}) through a pixel \vec{P}_{imgAUG} in the augmented image can be computed through the following:

$${\vec{o}}_{AUG} = {\tilde{P}}_{AUG}^{- 1} {\vec{e}}_{4} \qquad 29 )$$

$${\vec{d}}_{AUG} = {\tilde{P}}_{AUG}^{- 1} [ ( \begin{matrix}{\vec{𝒫}}_{imgAUG} \\ 1 \\ 0\end{matrix} ) + ( \begin{matrix}0.5 \\ 0.5 \\ \vec{0}\end{matrix} ) ] \qquad 30 )$$

$${\tilde{P}}_{AUG :=} [ \begin{matrix}{P}_{AUG} \\ {\vec{e}}_{4}^{T}\end{matrix} ] \qquad 31 )$$

where P_{AUG} is the camera projection matrix associated with the destination image.

The object point can be computed in the camera frame within the destination image via ray-mesh intersection, e.g.:

$${\vec{𝓍}}_{c a m A U G} = RayMeshIntersection ( {\vec{r}}_{c a m A U G} , \begin{matrix}T \\ camAUG ← disk\end{matrix} ( {mesh}_{d i s k} ) ) \qquad 32 )$$

Then, the locations on the transformed object mesh 244 (\vec{x}_{camAUG}) that intersected with the simulated camera rays may be mapped to an image point \vec{P}_{imgSRC} in the source object's frame as:

$${\vec{𝒫}}_{imgSRC} = \begin{matrix}P \\ camAUG ← disk\end{matrix} \cdot \begin{matrix}{T}^{- 1} \\ camAUG ← disk\end{matrix} {\vec{𝓍}}_{c a m A U G} \qquad 33 )$$

$${P}_{camAUG ← disk} := {P}_{SRC} H ( {L}_{SRC} ) {T}_{label ← disk}$$

The pixel values at the intersected points mapped to the source image can be sampled, for example, using bilinear interpolation. The pixel values at these locations on the source object's instance segmentation mask can also be sampled to ensure that the sampled pixel values are coming from the source object and not the background of the source image. This will be described in more detail with respect to step 116 in the LiDAR modality.

The pixel values at the pixels corresponding to the intersected locations in the destination image can then be replaced by the pixel values sampled from the source image. For example, as shown in FIG. 4, the destination image can include the corresponding pixel values of the source image 234 filled in at the locations on the transformed object that intersected with the simulated camera rays on the transformed mesh 244. Optionally, the transformed object can be labeled with a bounding box 410. Following sampling, a synthetic image 122 including the destination image augmented with the transformed object results.

Pasted images such as the transformed object can sometimes leave undesirable boundary artifacts. This can hinder generalization of a computer vision model trained from the image or point cloud, since the model can learn to recognize the object based on its artifact, rather than its identifying characteristics. Accordingly, sampling the transformed object's appearance from its source image can involve blending between the source image and the destination image by sampling alpha values from the object's instance segmentation mask. A Gaussian blur can be randomly applied around the transformed object to blur these artifacts. The transformed object can also be supersampled with four camera rays rather than one to further reduce artifacts.

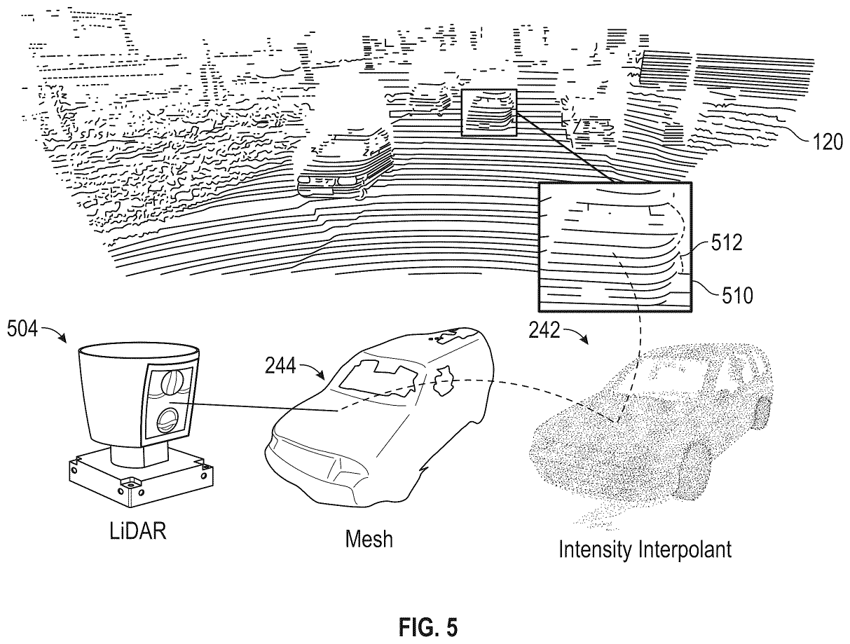

In the LiDAR modality, various techniques may be used to add LiDAR points on the transformed object and interpolate LiDAR intensities of the added points. A first technique is shown in FIG. 5. This technique may involve intersecting simulated LiDAR rays 504 with a transformed object mesh 244 having a valid pose transformation applied. Transformed object mesh 244 may be a transformed version of a LiDAR-specific source object mesh, will be described with respect to FIG. 2. Source object meshes can be transformed into the LiDAR frame according to:

$${T}_{lidAUG ← disk} = {T}_{camAUG ← lidAUG} * - 1 {T}_{camAUG ← disk} {T}_{camAUG ← lidAUG} *= {\tilde{R}}_{0 AUG} \cdot {T}_{camAUG ← lidAUG} \qquad 34 )$$

where \tilde{R}_{0AUG} is the homogenous form of the camera rectification rotation for the destination image, obtained from the source computer vision dataset it came from (e.g. KITTI, Waymo, etc.).

To simulate new LiDAR points, calibration parameters provided with the source computer vision dataset (e.g. KITTI, Waymo, etc.) may be used to compute the outgoing ray detection \vec{d} and origin \vec{o} for laser l. These can be computed as a function of the rotation angle ϕ of the LiDAR assembly as follows:

$$\vec{o} ( ϕ ) = [ \begin{matrix}- {v}_{0} sin θ sin ( ϕ - α ) - {h}_{o} cos ( ϕ - α ) \\ - {v}_{0} sin θ cos ( ϕ - α ) + {h}_{o} cos ( ϕ - α ) \\ {v}_{o} cos θ\end{matrix} ] \qquad 35 )$$

$$\vec{d} ( ϕ ) = [ \begin{matrix}sin θ sin ( ϕ - α ) \\ cos θ sin ( ϕ - α ) \\ sin θ\end{matrix} ] \qquad 36 )$$

where α (respectively θ) is the rotational (respectively vertical) correction factor and hₒ (respectively vₒ) is the horizontal (respectively vertical) offset for laser l.

If the destination point cloud is from the KITTI dataset, the LiDAR rays 504 may be simulated based on the firing pattern of a Velodyne HDL-64E S2, which simulates firing the top and bottom blocks of lasers simultaneously. However, the LiDAR rays may be based on other firing patterns depending on the firing pattern that was used to generate the source point cloud. LiDAR points on the surface of the transformed object mesh 244 may be computed as:

$${\vec{𝓍}}_{lidAUG} = RayMeshIntersection ( {\vec{𝓇}}_{lidAUG} , {T}_{lidAUG ← disk} ( {mesh}_{disk} ) ) \qquad 37 )$$

As with the image modality, the locations of the intersections may be projected onto the source object's instance segmentation mask. Segmentation masks are pixel-by-pixel labels indicating which portions of the transformed object mesh correspond to the source object or other objects that may be present in the source point cloud. LiDAR points may be projected onto the image frame containing the source object's segmentation mask as:

$${\vec{𝒫}}_{lid , imgSRC} = {P}_{ingSRC ← disk} \cdot {{T}_{lidAUG ← disk}}^{- 1} {\vec{x}}_{lidAUG} \qquad 38 )$$

Therefore, if a LiDAR ray falls outside the segmentation mask when projected onto the original LiDAR frame, it can be considered falling “outside” the source object (e.g. in the background), and that point may not be added to the transformed object. While using segmentation masks can help reduce boundary artifacts, other techniques may be used indicate which portions of the source point cloud correspond to the source object.

Then, points may be added to the transformed object in the destination point cloud based on the locations of the intersections of the simulated LiDAR rays with the transformed object mesh, as well as the projection onto the instance segmentation mask. A corresponding intensity for each added point can be defined using various methods. An exemplary method may use an intensity interpolant, shown as 242 in FIG. 5.

In some embodiments, LiDAR intensities can be modeled by the function ƒ(·,·). ƒ(·,·) may be used to map the origin \vec{o}_{lid} and intersection point \vec{x}_{lid} with surface normal \hat{n} of a LiDAR ray to the measured intensity value (ƒ(\vec{o}_{lid}, \vec{x}_{lid})). It can be observed that:

$$f ( {\vec{o}}_{lidAUG} , {\vec{x}}_{lidAUG} ) = f ( {\vec{o}}_{d i s k} , {\vec{x}}_{d i s k} ) \frac{f ( {\vec{o}}_{lidAUG} , {\vec{x}}_{lidAUG} )}{f ( {\vec{o}}_{disk} , {\vec{x}}_{d i s k} )} \qquad 39 )$$

Then, assuming that intensity ƒ(·,·) is roughly proportional to the optical power P received by the LiDAR sensor yields:

$$\begin{matrix}= f ( {\vec{o}}_{d i s k} , {\vec{x}}_{d i s k} ) \frac{k f ( {\vec{o}}_{lidAUG} , {\vec{x}}_{lidAUG} )}{k f ( {\vec{o}}_{disk} , {\vec{x}}_{d i s k} )} \\ \approx f ( {\vec{o}}_{disk} , {\vec{x}}_{d i s k} ) \frac{P ( {\vec{o}}_{lidAUG} , {\vec{x}}_{lidAUG} )}{P ( {\vec{o}}_{d i s k} , {\vec{x}}_{d i s k} )}\end{matrix} \qquad 40 )$$

It can also be assumed that object surfaces are Lambertian and intercept the full LiDAR beam, allowing the application of a simplified form of the LiDAR range equation as:

$$P ( \vec{o} , \vec{x} ) = \frac{{P}_{t} {D}_{r}^{2} {η}_{a t m} {η}_{s y s} ρ ( \vec{x} )}{4 {‖ \vec{x} - \vec{o} ‖}^{2}} cos α \qquad 41 )$$

where ρ(x) is the reflectance of the object's surface at x and α is the angle of incidence of the LiDAR ray with the object's surface at point \vec{x}. Pt is the optical power transmitted by the LiDAR, Dᵣ is the receiver aperture diameter, ηₐₜₘ is the atmospheric transmission factor, and η_{sys} is the system transmission factor (all assumed constant across the dataset).
Thus, Equation 41 can be simplified as:

$$= \frac{k ρ ( \vec{x} )}{{‖ \vec{x} - \vec{o} ‖}^{2}} cos α \qquad 42 )$$

Substituting Equation 42 into Equation 40 Yields:

$$f ( {\vec{o}}_{lidAUG} , {\vec{x}}_{lidAUG} ) \approx f ( {\vec{o}}_{d i s k} , {\vec{x}}_{disk} ) \frac{k ρ ( {\vec{x}}_{lidAUG} ) cos {α}_{lidAUG} {‖ {\vec{x}}_{d i s k} - {\vec{o}}_{d i s k} ‖}^{2}}{{( ‖ {\vec{x}}_{lidAUG} ) - {\vec{o}}_{lidAUG} ‖}^{2} k ρ ( {\vec{x}}_{disk} ) cos {a}_{disk}} = \frac{ρ ( {\vec{x}}_{lidAUG} ) cos {α}_{lidAUG} f ( {\vec{o}}_{d i s k} , {\vec{x}}_{d i s k} ) {‖ {\vec{x}}_{d i s k} - {\vec{o}}_{d i s k} ‖}^{2}}{{‖ {\vec{x}}_{lidAUG} - {\vec{o}}_{lidAUG} ‖}^{2} ρ ( {\vec{x}}_{d i s k} ) cos {α}_{d i s k}} \qquad 43 )$$

As long as the relative pose between the object surface and the sensor is maintained, the LiDAR intensity ƒ(·,·) is invariant to changes in reference frame. Therefore:

$$\frac{ρ ( {T}_{disk ← lidAUG} {\vec{x}}_{lidAUG} ) cos {α}_{lidAUG}}{{‖ {T}_{disk ← lidAUG} ( {\vec{x}}_{lidAUG} - {\vec{o}}_{lidAUG} ) ‖}^{2}} \cdot \frac{f ( {\vec{o}}_{disk} , {\vec{x}}_{disk} ) {‖ {\vec{x}}_{disk} - {\vec{o}}_{disk} ‖}^{2}}{ρ ( {\vec{x}}_{disk} ) cos {α}_{disk}} \qquad 44 )$$

ρ(·), the surface reflectance, should be relatively smooth on small scales, so \vec{x}≈\vec{x}′⇒ρ(\vec{x})≈ρ(\vec{x}′). Assuming the data used to construct the cut object contained a point on the surface near the new point sample, this allows Equation 44 to be further simplified to:

$$\begin{matrix}\approx \frac{cos {α}_{lidAUG}}{{‖ {T}_{disk ← lidAUG} ( {\vec{x}}_{lidAUG} - {\vec{o}}_{lidAUG} ) ‖}^{2}} \cdot \frac{f ( {\vec{o}}_{disk} , {\vec{x}}_{disk} ) {‖ {\vec{x}}_{disk} - {\vec{o}}_{disk} ‖}^{2}}{cos {α}_{disk}} \\ = \frac{cos {α}_{lidAUG}}{{‖ {T}_{disk ← lidAUG} ( {\vec{x}}_{lidAUG} - {\vec{o}}_{lidAUG} ) ‖}^{2}} \cdot b ( {\vec{x}}_{disk} )\end{matrix} \qquad 45 )$$

$$where b ( {\vec{x}}_{disk} ) = \frac{f ( {\vec{o}}_{disk} , {\vec{x}}_{disk} ) {‖ {\vec{x}}_{disk} - {\vec{o}}_{disk} ‖}^{2}}{cos {α}_{disk}}$$

### Since

$${T}_{disk ← lidAUG}$$

\vec{x}_{lidAUG} is generally not present in the source object's point cloud, b(\vec{x}_{disk}) can be approximated by building a linear interpolant lerp (\vec{x}_{disk}) over the points corresponding to the source object in the source point cloud (shown by way of example as intensity interpolant 242). cos α_{lidAUG} can be estimated from the surface normal of the transformed object mesh \hat{n} at the point of intersection as:

$$cos {α}_{lidAUG} = ( \cdot \hat{𝓃} \qquad 46 )$$

cos α_{disk} can be estimated using a local tangent plane approximation using its neighbors for the surface normal. This results in the following functions for filling in the intensity of each simulated LiDAR point on the transformed object:

$$f ( {\vec{o}}_{lidAUG} , {\vec{x}}_{lidAUG} ) \approx \frac{{\hat{r}}_{disk} \cdot \hat{n}}{{‖ {r}_{disk} ‖}^{2}} \cdot lerp ( {T}_{disk ← lidAUG} {\vec{x}}_{lidAUG} ) \qquad 47 )$$

$${\vec{r}}_{disk} = {T}_{disk ← lidAUG} ( {\vec{x}}_{lidAUG} - {\vec{o}}_{lidAUG} ) \qquad 48 )$$

These values, including the interpolant, can be computed in the log space to improve numerical stability and replace the smooth arithmetic mean with a sharper geometric mean. Simulated intensities can be scaled and rounded to match the domain of the intensity values provided in a computer vision dataset (e.g. KITTI).

Another exemplary method of sampling the intensities of the LiDAR points added to the transformed object is by sampling intensity values from the LiDAR-specific version of the source object mesh having embedded intensity values, which will be described with respect to FIG. 2. Simulated LiDAR rays can be fired at the transformed object mesh 244 as outlined above, and locations at which the LiDAR rays intersect with the transformed object mesh 244 can be determined. The intersected locations can be transformed back into the source object frame and projected onto the source object mesh. The intensity values of points at the projected locations on the source object mesh can be sampled, and the intensity values of the points on the transformed object at these locations can be assigned based on the sampled intensity values.

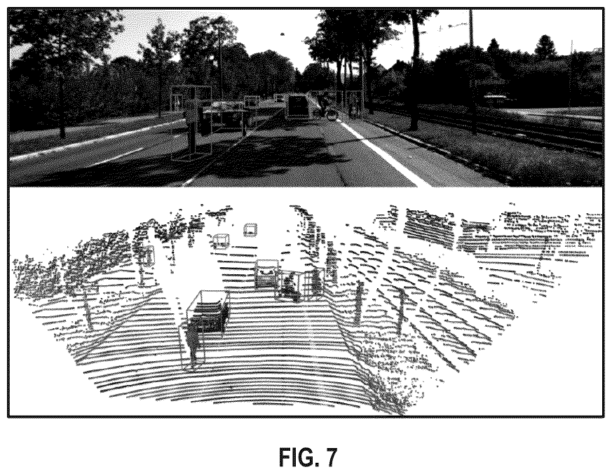

Referring still to FIG. 1, following sampling, a synthetic point cloud 120 including the destination point cloud augmented with the transformed object results. The synthetic point cloud 120 and synthetic image 122 each make up synthetic multimodal training data 124 that can be used to train a computer vision model at step 126. FIG. 7 illustrates an example of synthetic multimodal training data including a synthetic image and a synthetic point cloud. Objects that were originally in the destination image and point cloud are drawn in green boxes, while objects that have been added are drawn in red boxes. Any standard iterative training procedure may be used to train the computer vision model, and method 100 may be used with any suitable multimodal computer vision model (e.g. the MMDetection3D implementation of MVX-Net). Following step 126, the synthetic multimodal training data 124 may be discarded, and method 100 may be repeated starting back at step 102.

Prior to performing method 100, a dataset of source objects 102 can be built for use during method 100. A method for building the dataset of source objects is shown in FIG. 2. The steps shown in FIG. 2 may only need to be performed once, prior to training a computer vision model, whereas the steps in method 100 may be repeated many times over the course of training the model. Referring to FIG. 2, building the dataset of source objects may begin with source point clouds 230 and source images 234, which may be from an already existing dataset for use in training computer vision models, such as those used in autonomous vehicles. In some embodiments, the computer vision dataset may include some or all of the KITTI dataset. Other possible datasets include Waymo, nuScenes, etc. The source point clouds 230 and source images 230 may also be labeled with source detection labels 232, such as bounding boxes and timestamps.

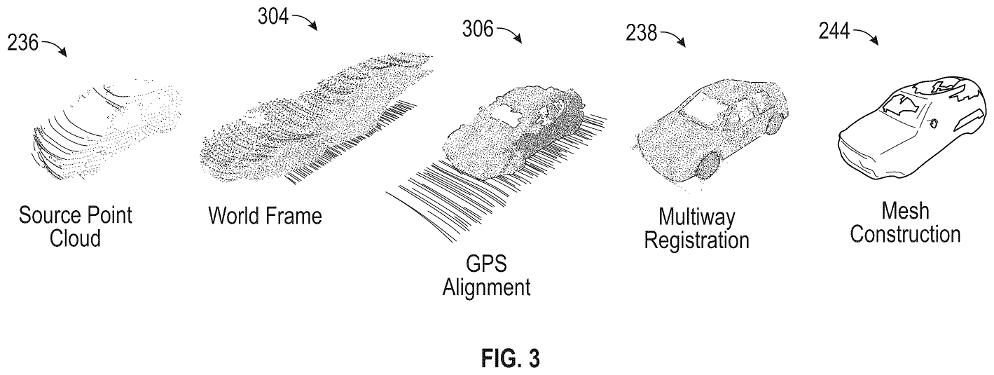

Each source point cloud 230 and source image 234 may contain one or more objects. At step 236, an object of interest in the source point cloud 230 can be singled out using the source detection labels 232, and the source point cloud 230 can be cropped beyond the object of interest. For rigid objects such as cars, several steps may be performed to construct a high-quality object mesh from the cropped point cloud 236. Visualizations of these steps are shown in FIG. 3. At step 304, a sequence of point clouds from the preexisting computer vision dataset (e.g. KITTI, Waymo, nuScenes) can be transformed into a static world frame, in accordance with GPS/IMU readings and calibrations provided in the dataset. Then, at step 306, the point clouds can be coarsely aligned into a common object frame.

At step 238 (also illustrated in FIG. 2), multiway registration can be performed using colored iterative closest point (ICP), using intensity features as colors. For global consistency, a pose graph can be constructed and optimized for joint registration of object point clouds, which jointly optimizes corrections to the coarse estimates. A random sample consensus (RANSAC) algorithm can be used to remove ground plane points, optionally taking place between 306 and 238 in FIG. 3 and shown by way of example at step 240 in FIG. 2. The RANSAC algorithm may be a standard planar fit RANSAC with an added constraint specifying that the proposed plane's normal should be reasonably parallel to the height axis. Referring back to FIG. 2, step 240 may also involve removing outlier points.

At step 244, shown in FIGS. 2 and 3, object meshes can be constructed. The object meshes are surface representations of the object that can be made up of many triangular units that are connected together by their common edges and vertices. Although only one object mesh is shown in FIG. 3, in actuality, an image-specific object mesh and a LiDAR-specific object mesh can both be constructed for each source object. Steps 230, 236, 238, and 240 may be performed in the same manner for both the image and LiDAR specific object meshes.

Notably, the object meshes may be constructed from the source point clouds 230, and LiDAR penetrates glass. Therefore, for an object such as a car, the windows would lack supporting LiDAR points from which the mesh can be constructed. To ensure that the object meshes have no interior holes despite the missing window points, a screened Poisson reconstruction can be performed. The Poisson reconstruction may take a point cloud and its surface normals and return a plausible mesh describing the surface of an object that those points may have been sampled from. For the LiDAR-specific mesh, the portions of the mesh corresponding to the windows may still be treated as invisible when simulating LiDAR rays intersecting with the mesh.

The LiDAR-specific mesh may optionally be embedded with intensity values that can be sampled at step 116 in method 100. To embed intensity values into the mesh, LiDAR rays can be intersected with the LiDAR-specific source object mesh. Each triangle on the mesh that intersected with the LiDAR rays can be associated with the average of the intensities of the set of simulated rays that intersected with it. A graph can then be constructed from the mesh where every triangle of the mesh is a node, and triangles that share a face are adjacent. A least-squares optimization procedure can be used over the graph to fill in the intensity values for triangles without associated intensities and smooth the intensities associated with the mesh.

Finally, surfaces extending beyond a bounding box of the source object can be trimmed, and the complete source object meshes 244 result. Notably, this method of constructing object meshes is only exemplary, and other suitable methods may be used. Also, for deformable objects such as pedestrians and bicyclists, their meshes can be constructed from a single point cloud, since combining point clouds of a deformable object over time may cause certain parts of the object to “smear” in the point cloud.

Referring back to FIG. 2, in addition to the object meshes 244, an intensity interpolant 242 may also be created in the manner described with respect to FIG. 5. The object meshes 244 and the intensity interpolant 242 may be transformed into a canonical reference frame so that they can be stored on a disk. Color can be simulated by painting the object of interest's source image onto a mesh (e.g. the image-specific object mesh), resulting in a “cut” source object that can be used during multimodal ground truth sampling. Another object of interest may be “cut” from the source point cloud 230 at step 236, and steps 236-244 can be repeated for as many objects of interest that are desired to be included in the dataset. These “cut” objects 246 can be saved, along with their source detection labels 232, object meshes 244, intensity interpolants 242, and sensor information from the original dataset (e.g. for use in simulating camera rays/LiDAR firing patterns) to create a dataset of source objects 102. Source objects from this dataset may then be sampled during method 100 while training the computer vision model.

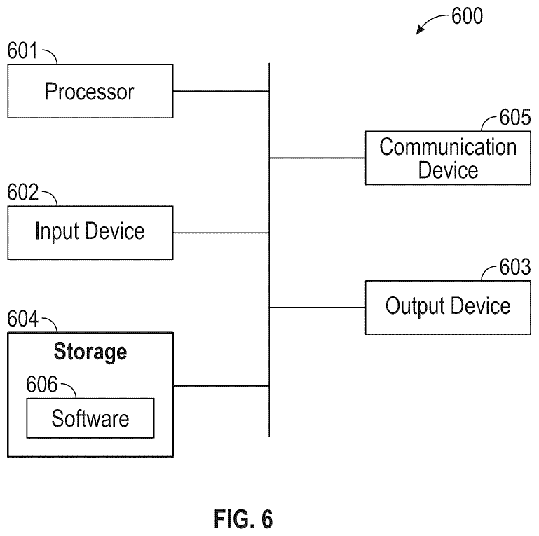

In some embodiments, a system for implementing the multimodal ground truth sampling methods described herein is provided. The system may include a computer, as shown in FIG. 6. Computer 600 can be a host computer connected to a network. Computer 600 can be a client computer or a server. As shown in FIG. 6, computer 600 can be any suitable type of microprocessor-based device, such as a personal computer, workstation, server, videogame console, or handheld computing device, such as a phone or tablet. The computer can include, for example, one or more of processor 601, input device 602, output device 603, storage 604, and communication device 605. Input device 602 can generally correspond to those described above and can either be connectable or integrated with the computer. In some embodiments, computer 600 and/or processor 601 may include a graphics processing unit (GPU).

Input device 602 can be any suitable device that provides input, such as a touch screen or monitor, keyboard, mouse, or voice-recognition device. Output device 603 can be any suitable device that provides output, such as a touch screen, monitor, printer, disk drive, or speaker.

Storage 604 can be any suitable device that provides storage, such as an electrical, magnetic, or optical memory, including a RAM, cache, hard drive, CD-ROM drive, tape drive, removable storage disk, or other non-transitory computer readable medium. Storage 604 can include one storage device or more than one storage device. As used herein, the terms storage, memory, and/or storage medium/media may refer to singular and/or plural devices which may store data and/or code/instructions individually, redundantly, and/or in cooperation with one another, for example in a local and/or cloud storage environment. Communication device 505 can include any suitable device capable of transmitting and receiving signals over a network, such as a network interface chip or card. The components of the computer can be connected in any suitable manner, such as via a physical bus or wirelessly. Storage 604 can be a non-transitory computer-readable storage medium comprising one or more programs, which, when executed by one or more processors, such as processor 601, cause the one or more processors to execute methods described herein.

Software 606, which can be stored in storage 604 and executed by processor 601, can include, for example, the programming that embodies the functionality of the present disclosure (e.g., as embodied in the systems, computers, servers, and/or devices as described above). In some embodiments, software 606 can be implemented and executed on a combination of servers such as application servers and database servers.

Software 606, or part thereof, can also be stored and/or transported within any computer-readable storage medium for use by or in connection with an instruction execution system, apparatus, or device, such as those described above, that can fetch and execute instructions associated with the software from the instruction execution system, apparatus, or device. In the context of this disclosure, a computer-readable storage medium can be any medium, such as storage 604, that can contain or store programming for use by or in connection with an instruction execution system, apparatus, or device.

Software 606 can also be propagated within any transport medium for use by or in connection with an instruction execution system, apparatus, or device, such as those described above, that can fetch and execute instructions associated with the software from the instruction execution system, apparatus, or device. In the context of this disclosure, a transport medium can be any medium that can communicate, propagate, or transport programming for use by or in connection with an instruction execution system, apparatus, or device. The transport-readable medium can include, but is not limited to, an electronic, magnetic, optical, electromagnetic, or infrared wired or wireless propagation medium.

Computer 500 may be connected to a network, which can be any suitable type of interconnected communication system. The network can implement any suitable communications protocol and can be secured by any suitable security protocol. The network can comprise network links of any suitable arrangement that can implement the transmission and reception of network signals, such as wireless network connections, T1 or T3 lines, cable networks, DSL, or telephone lines. Alternatively, an internet connection may not be required to carry out method 100.

Computer 600 can implement any operating system suitable for operating the network. Software 606 can be written in any suitable programming language, such as C, C++, Java, or Python. In various embodiments, application software embodying the functionality of the present disclosure can be deployed in different configurations, such as in a client/server arrangement or through a web browser as a Web-based application or Web service, for example.

### EXAMPLES

### Example 1. Comparison Against Existing Ground Truth Sampling Methods

In this example, the KITTI training set was partitioned into the standard train/validation split of 3,712/3,769 samples, respectively. Source object meshes were constructed exclusively from the training set, yielding 2,083 cars, 433 pedestrians, and 65 cyclists. For each frame, the distribution of objects was sampled using a distribution of p(car)=0.5, and p(pedestrian)=p(cyclists)=0.25. Each destination image/point cloud contained a maximum of 5 transformed objects.

A proposed ground truth sampling method was validated by training the MMDetection3D implementation of MVX-Net from scratch using the KITTI training set. Aside from the addition of the ground truth sampling method proposed herein, the default training configuration of MVX-Net implemented with MMDetection3D was used, which also includes global point cloud augmentations, horizontal flips, and image rescaling. Global point cloud transformations were inverted prior to the point fusion model.

The quality of the detection results of the MVX-Net trained using the proposed ground truth sampling method are shown below in Tables 1 and 2. The results were evaluated using KITTI dataset metrics such as average position (AP) computed across 40 recall positions, with an intersection over union (IoU) threshold of 0.7 for cars and 0.5 for pedestrians and cyclists. The 3D AP is shown in Table 1, while the Bird's Eye View (BEV) AP is shown in Table 2.

TABLE 1
3D AP on KITTI Validation Set

| | Car | | | | Pedestrian | | | | Cyclist | | | |
|---|---|---|---|---|---|---|---|---|---|---|---|---|
| Method | Easy | Mod | Hard | mAP | Easy | Mod | Hard | mAP | Easy | Mod | Hard | mAP |
| MVX-Net | 85.5 | 73.3 | 67.4 | 75.4 | — | — | — | — | — | — | — | — |
| MVX-Net + | 87.9 | 77.6 | 76.0 | 80.5 | 68.6 | 61.9 | 54.7 | 61.7 | 86.0 | 71.2 | 65.0 | 74.1 |
| MoCa | | | | | | | | | | | | |
| MVX-Net + | 87.3 | 79.4 | 74.8 | 80.5 | 68.2 | 62.3 | 57.7 | 62.7 | 86.8 | 74.6 | 62.8 | 74.7 |
| Context | | | | | | | | | | | | |
| MVX-Net + | 89.2 | 79.1 | 76.3 | 81.5 | 65.3 | 60.0 | 56.4 | 60.6 | 82.7 | 63.8 | 60.5 | 69.0 |
| Proposed | | | | | | | | | | | | |
| Method | | | | | | | | | | | | |

TABLE 2
BEV AP on KITTI Validation Set

| | Car | | | | Pedestrian | | | | Cyclist | | | |
|---|---|---|---|---|---|---|---|---|---|---|---|---|
| Method | Easy | Mod | Hard | mAP | Easy | Mod | Hard | mAP | Easy | Mod | Hard | mAP |
| MVX-Net | 89.5 | 84.9 | 79.0 | 84.5 | — | — | — | — | — | — | — | — |
| MVX-Net + | — | — | — | — | — | — | — | — | — | — | — | — |
| MoCa | | | | | | | | | | | | |
| MVX-Net + | 90.3 | 88.3 | 84.8 | 87.8 | 77.4 | 66.9 | 68.2 | 70.9 | 86.3 | 82.3 | 75.1 | 81.2 |
| Context | | | | | | | | | | | | |
| MVX-Net + | 92.7 | 88.2 | 85.6 | 88.9 | 71.7 | 66.2 | 62.3 | 66.7 | 84.1 | 66.1 | 62.2 | 70.8 |
| Proposed | | | | | | | | | | | | |
| Method | | | | | | | | | | | | |

As shown, the method proposed herein outperforms the previous state-of-the-art multimodal ground truth sampling algorithm by 1.0 3D mAP and 1.1 BEV mAP on the car class. Additionally, the improved performance of the car class can be attributed in part to the improved accuracy of the source car meshes, which can be prepared from combined LiDAR point clouds as described above, while the pedestrian and cyclist object meshes were prepared from a single point cloud. Additionally, the KITTI dataset contains more cars than pedestrians and cyclists, so the object meshes created from this dataset are more varied, and the MVX-Net is thus better at generalization with respect to cars.

1. A method of multimodal ground truth sampling for creating synthetic multimodal training data, the method performed by one or more processors, the method comprising:
selecting a source object from a dataset;
determining a valid pose transformation from a set of proposed pose transformations;
applying the valid pose transformation to the source object to create a transformed object;
generating synthetic image data based on the transformed object and a destination image;
generating synthetic point cloud data based on the transformed object and a destination point cloud; and
training a computer vision machine learning model from synthetic multimodal training data comprising the synthetic image data and the synthetic point cloud data.

2. The method of claim 1, wherein generating synthetic image data based on the transformed object and the destination image comprises:
intersecting simulated camera rays with locations on a transformed object mesh, wherein the transformed object mesh corresponds to the transformed object;
sampling pixel values in a source image based on the intersected locations, wherein the source image corresponds to the source object; and
replacing pixel values of the destination image with the sampled pixel values in the source image.

3. The method of claim 1, wherein generating synthetic point cloud data based on the transformed object and the destination point cloud comprises:
removing points from the destination point cloud that are occluded by the transformed object;
intersecting simulated LiDAR rays with locations on a transformed object mesh, wherein the transformed object mesh corresponds to the transformed object;
sampling intensity values in a source object mesh based on the intersected locations, wherein the source object mesh corresponds to the source object;
adding points to the destination point cloud at locations on the transformed object corresponding to the intersected locations; and
assigning intensity values for the added points based on the sampled intensity values.

4. The method of claim 1, further comprising labeling the synthetic multimodal training data with one or more of an object class, a yaw, a length, a width, a height, an x-coordinate, a y-coordinate, or a z-coordinate.

5. The method of claim 1, wherein prior to selecting a source object from a dataset, the method comprises:
combining LiDAR points from one or more source point clouds into a combined point cloud;
constructing a source object mesh from the combined point cloud;
constructing a source object from the source object mesh and one or more source images; and
saving the source object to the dataset.

6. The method of claim 5, wherein constructing the source object mesh from the combined point cloud comprises removing outlier points.

7. The method of claim 5, wherein constructing the source object mesh from the combined point cloud comprises removing points corresponding to a ground plane.

8. The method of claim 1, wherein determining a valid pose transformation from a set of proposed pose transformations comprises determining that applying the proposed pose transformation to the source object to create a transformed object would not cause the transformed object to violate one or more occlusion criteria.

9. The method of claim 8, wherein determining a valid pose transformation from a set of proposed pose transformations comprises:
measuring a first pixel length of a bounding box around the source object;
measuring a second pixel length of a bounding box around the source object transformed using a proposed pose transformation;
computing a ratio of the second pixel length to the first pixel length; and
determining that the ratio does not exceed a distortion threshold.

10. The method of claim 8, wherein determining a valid pose transformation from a set of proposed pose transformations comprises determining that applying the proposed pose transformation to the source object to create a transformed object would not cause the transformed object to overlap with one or more objects in the destination image.

11. The method of claim 1, wherein the source object is one of a vehicle, a pedestrian, or a bicyclist.

12. A system for multimodal ground truth sampling for creating synthetic multimodal training data, the system comprising:
one or more processors; and
memory storing computer program code executable by the one or more processors to cause the system to:
select a source object from a dataset;
determine a valid pose transformation from a set of proposed pose transformations;
apply the valid pose transformation to the source object to create a transformed object;
generate synthetic image data based on the transformed object and a destination image;
generate synthetic point cloud data based on the transformed object and a destination point cloud; and
train a computer vision machine learning model from synthetic multimodal training data comprising the synthetic image data and the synthetic point cloud data.

13. The system of claim 12, wherein generating synthetic image data based on the transformed object and the destination image comprises:
intersecting simulated camera rays with locations on a transformed object mesh, wherein the transformed object mesh corresponds to the transformed object;
sampling pixel values in a source image based on the intersected locations, wherein the source image corresponds to the source object; and
replacing pixel values of the destination image with the sampled pixel values in the source image.

14. The system of claim 12, wherein generating synthetic point cloud data based on the transformed object and the destination point cloud comprises:
removing points from the destination point cloud that are occluded by the transformed object;
intersecting simulated LiDAR rays with locations on a transformed object mesh, wherein the transformed object mesh corresponds to the transformed object;
sampling intensity values in a source object mesh based on the intersected locations, wherein the source object mesh corresponds to the source object;
adding points to the destination point cloud at locations on the transformed object corresponding to the intersected locations; and
assigning intensity values for the added points based on the sampled intensity values.

15. The system of claim 12, wherein the system is further caused to label the synthetic multimodal training data with one or more of an object class, a yaw, a length, a width, a height, an x-coordinate, a y-coordinate, or a z-coordinate.

16. The system of claim 12, wherein prior to selecting a source object from a dataset, the system is caused to:
combine LiDAR points from one or more source point clouds into a combined point cloud;
construct a source object mesh from the combined point cloud;
construct a source object from the source object mesh and one or more source images; and
save the source object to the dataset.

17. The system of claim 16, wherein constructing the source object mesh from the combined point cloud comprises removing outlier points.

18. The system of claim 16, wherein constructing the source object mesh from the combined point cloud comprises removing points corresponding to a ground plane.

19. The system of claim 12, wherein determining a valid pose transformation from a set of proposed pose transformations comprises determining that applying the proposed pose transformation to the source object to create a transformed object would not cause the transformed object to violate one or more occlusion criteria.

20. The system of claim 19, wherein determining a valid pose transformation from a set of proposed pose transformations comprises:
measuring a first pixel length of a bounding box around the source object;
measuring a second pixel length of a bounding box around the source object transformed using a proposed pose transformation;
computing a ratio of the second pixel length to the first pixel length; and
determining that the ratio does not exceed a distortion threshold.

21. The system of claim 19, wherein determining a valid pose transformation from a set of proposed pose transformations comprises determining that applying the proposed pose transformation to the source object to create a transformed object would not cause the transformed object to overlap with one or more objects in the destination image.

22. The system of claim 12, wherein the source object is one of a vehicle, a pedestrian, or a bicyclist.

23. A non-transitory computer readable storage medium storing one or more programs, the one or more programs comprising instructions, which, when executed by a system, cause the system to:
select a source object from a dataset;
determine a valid pose transformation from a set of proposed pose transformations;
apply the valid pose transformation to the source object to create a transformed object;
generate synthetic image data based on the transformed object and a destination image;
generate synthetic point cloud data based on the transformed object and a destination point cloud; and
train a computer vision machine learning model from synthetic multimodal training data comprising the synthetic image data and the synthetic point cloud data.
